(19) United States
(12) Patent Application Publication
(10) Pub. No.: US 2005/0045442 A1
(43) Pub. Date: Mar. 3, 2005

(54) Coupling arrangement

(76) Inventors: Tobias Godecke, Kernen (DE); Ludger Kortenjanin, Warendorf (DE)

Correspondence Address: KLAUS J. BACH, 4407 TWIN OAKS DRIVE, MURRYSVILLE, PA, 15668, US

(21) Appl. No.: 10/922,398

(22) Filed: Aug. 20, 2004

(30) Foreign Application Priority Data
Aug. 27, 2003 (DE) 103 39 757.4

(51) Int. Cl. F16H 61/14

(52) U.S. Cl. 192/3.33

(57) ABSTRACT

In a coupling arrangement disposed between a drive shaft and a driven shaft for transferring a torque between the drive shaft and the driven shaft and comprising a hydrodynamic startup unit, and a bridging clutch bridging the startup unit and having an engagement pressure provided by a combination of a control pressure and a counter pressure, a control unit is provided for controlling the counter pressure in at least one state of operation of the coupling arrangement so as to permit a certain slippage of the bridging clutch.

### BACKGROUND OF THE INVENTION

The invention resides in a coupling arrangement including a startup unit, a control unit and a bridging clutch whose engagement pressure is generated by a force combination of at least one counter pressure and a control pressure.

Such a coupling arrangement with a hydrodynamic startup unit, a control unit and a bridging clutch whose engagement pressure is provided to form a force equilibrium with a counter pressure and a control pressure is known in the art. The control pressure is adjusted by the control unit of the coupling arrangement whereas the counter pressure is determined by an internal pressure of the hydrodynamic start-up unit of the coupling arrangement, that is, of a torque converter. The internal pressure is derived from the lubricant pressure by way of a restrictor.

Is the object of the present invention to provide a coupling arrangement which requires only a relatively small space and which provides under all operational conditions for a fast and accurate control of the engagement pressure of a bridging clutch.

### SUMMARY OF THE INVENTION

In a coupling arrangement disposed between a drive shaft and a driven shaft for transferring a torque between the drive shaft and the driven shaft and comprising a hydrodynamic startup unit, and a bridging clutch bridging the startup unit and having an engagement pressure provided by a combination of a control pressure and a counter pressure, a control unit is provided for controlling the counter pressure in at least one state of operation of the coupling arrangement so as to permit a certain slippage of the bridging clutch.

The invention is based on a coupling arrangement with a preferably hydrodynamic start-up unit, a control unit, and a bridging clutch whose engagement pressure results from a force equilibrium with at least one counter-pressure and a control pressure.

In accordance with the invention, the counter pressure is controllable by means of the control unit in at least one operating state. In this way, advantageously, a predetermined counter pressure can be provided and a well-defined relationship between the control pressure and the engagement pressure can be obtained. Particularly the torque being transmitted by the bridging clutch or its slippage can be controlled in an advantageous manner. An excessive engine speed and a corresponding heat generation in the startup unit can be avoided. Furthermore, humming of the drive line can be avoided by damping torsion vibrations at the bridging clutch by way of a certain controlled slippage.

The functions can advantageously be provided if the counter pressure is determined by an internal pressure of the start-up unit. Then the start-up unit and the bridging clutch can also be accommodated in a common housing in a space saving manner.

If the control unit adjusts the counter pressure in at least one mode of operation to an essentially constant value a time-dependent adjustment between the control pressure and the counter pressure can be avoided and control pressure-friction engagement characteristic (curve) can be obtained which is time-independent. However, in accordance with the invention, also coupling arrangements and/or methods of operation are possible wherein the control pressure and the counter pressure are time-dependent in a predetermined way or wherein the control pressure assumes a constant value whereas the bridging clutch is operated essentially by the counter pressure.

In another embodiment of the invention, the control unit adjusts the internal pressure in at least one operational state to an essentially constant value when a supply pressure exceeds a threshold value. In this way, advantageously an internal pressure which is independent of variations of the supply pressure can be achieved as long as the variations do not drop below the threshold value. The operating medium supply of the start-up unit and the bridging clutch can then be arranged in a space-saving series arrangement, wherein the control unit may be arranged ahead thereof, particularly if the supply pressure is formed by the lubricant pressure.

If the threshold value is less than 20% of a saturation value even large variations of the supply pressure about the saturation value will not cause the supply pressure to fall below the threshold value. Furthermore, already at an early point in time during the buildup phase of the supply pressure a constant internal pressure and consequently a constant and controlled counter pressure of the bridging clutch can be obtained. In this connection, saturation values of the supply pressure between 3 and 10 bar with regard to a pressure loading of the pressure passages and flow rate of the operating fluid are realistic so that the threshold value is preferably in the range of 0.3 to 1 bar.

If the control unit includes at least one control spool valve at least one hydraulic pressure can be controlled in an inexpensive and reliable manner. Then, in particular embodiments of the spool valve, wherein the lubricant pressure is effective against a spring force, an absolute measure for the control of the hydraulic pressure can be realized by the spring force in an inexpensive way.

If the internal pressure is derived by way of the control spool valve from a lubricant pressure, no additional pressure lines and pressure generating units are needed.

If the bridging clutch can be engaged by way of the control unit only when the internal pressure is at the constant value, the bridging clutch cannot be operated with an excessively low counter pressure. In addition, no damages can occur as a result of excessive acceleration values which may occur by a sudden engagement of the bridging clutch or by a surge of the engine speed.

If the control unit retains the control valve in at least one operating state in an open position of, the flow rate through the control spool can in this position be at a maximum. During phases of high heat generation in a hydrodynamic startup unit wherein the bridging clutch is generally disengaged a high cooling rate can be achieved therefore. The spool valve can be retained in a particular position in an advantageous inexpensive and reliable manner if it is held in position in at least one operating state by an operating pressure.

In another embodiment of the invention, a first control spool valve is provided for the control of the internal pressure and a second control spool valve is provided for the setting of the control pressure. In this way, the two pressures can be adjusted independently from one another and advantageously adapted to the requirements which are independent from the generation of the engagement pressure.

If the control spool valve for the internal pressure can be retained in position by the control spool valve via a control line, the operation of the two control spool valves can be tuned during a switch-over between different modes of operation in an advantageous and simple manner.

Further advantages of the invention will become more readily apparent from the following description on the basis of the accompanying drawings showing the various features of the invention in a particular combination.

### BRIEF DESCRIPTION OF THE DRAWINGS

FIG. 1 is a schematic representation of a coupling arrangement,

FIG. 2 shows a control spool valve of the coupling arrangement shown in FIG. 1 in a retain configuration, and

FIG. 3 shows the control spool valve of FIG. 2 in a control configuration.

### DESCRIPTION OF A PREFERRED EMBODIMENT

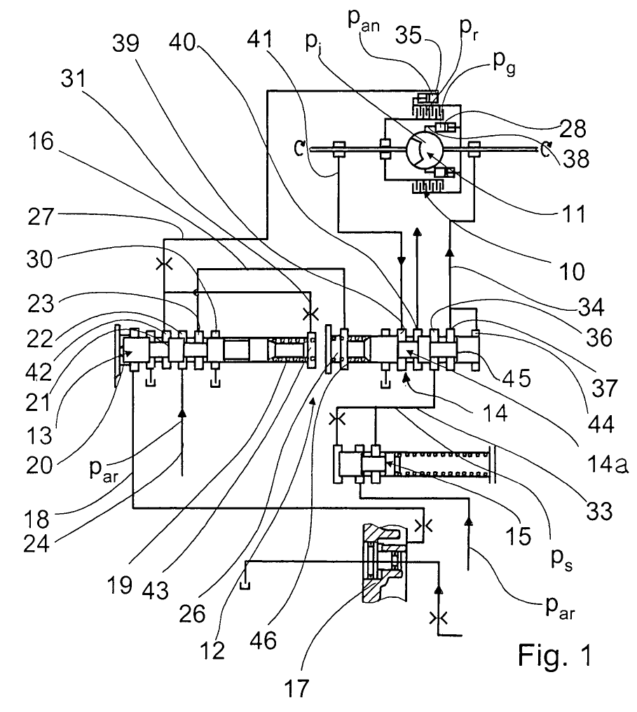

FIG. 1 shows schematically a coupling arrangement with a hydrodynamic start up unit 11, a control unit 12 and a bridging clutch 10 whose engagement pressure pᵣ is generated by a force equilibrium with a counter pressure p_{g} and a control pressure pₐₙ. The control unit 12 comprises the two control spool valves 13 and 14 and controls the counter pressure p_{g} in an operational mode which is characterized by an essentially complete torque transfer by the bridging clutch 10 to an essentially constant value of 0.5 bar (FIGS. 1 and 3).

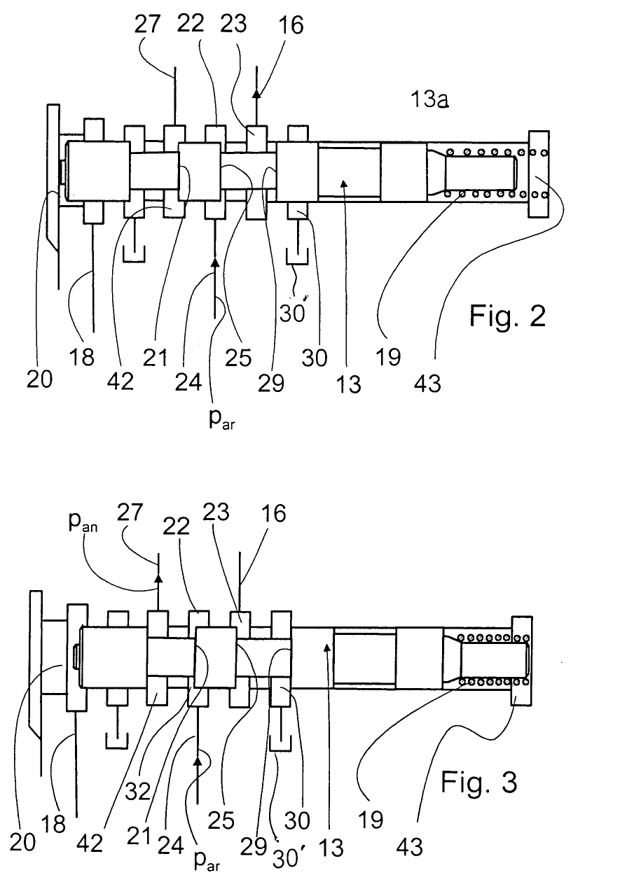

A second operational mode is characterized by an open bridging clutch 10, and with a rotating drive shaft, by a high dissipation in the hydrodynamic startup unit 11 (FIGS. 1 and 2). In that case, no voltage is applied to an electromagnetic control valve 17, which has an ascending characteristic and which is only partially shown in FIG. 1. As a result, the magnetic control valve 17 is closed and a pressure line 18 connected to a pressure chamber 20 of a control spool valve 13 is vented.

A spring 19 is disposed at an end of the control spool valve 13, including a central spool 13a which is axially movably disposed in a bore and, with one end, engages an end face of the bore 13a of the spool valve 13. The control spool 13a is subjected to the hydraulic pressure in the pressure chamber 20. in the second mode of operation, the control spool 13a is moved by the spring 10 toward the pressure chamber 20 so that a reduced cross-section area of the control spool 13a extends over two annular grooves 22, 23 in the bore of the valve 13 (FIG. 2). The first annular groove 22 is in communication with an operating fluid supply line 24 and the second annular groove 23 is in communication with a control line 16 extending between the control spool valve 13 and another control spool valve 14. From the first annular groove 22, the operating fluid pressure pₐₙ of the operating fluid supply line 24 is transmitted by way of the reduced diameter area of the spool 13a to the second annular groove 23 and, by way of the control line 16, to the pressure chamber 26 of the second control spool valve 14. The operating pressure pₐᵣ generates at an end face of the control spool 14a delimiting the pressure chamber 26 of the second control spool valve 14, a large force, which retains the second control spool 14a in a position in which, by way of the two annular grooves 36, 37 and a reduced cross-section area of the spool 14a, the control fluid pressure which is derived from a lubricant pressure p₃ in a lubricant line 33, is transmitted by way of the second control spool valve 14 and a pressure line 34 to the startup unit 11. The operating fluid flows through the startup unit 11 for cooling the unit and generates therein an internal pressure pᵢ, which is derived from the lubricant pressure pₛ. From the startup unit 11, the operating fluid is conducted by way of a pressure line 41 via two annular grooves 39, 40 and another reduced cross-section area of the second valve spool 14a to a cooler which is not shown.

The internal pressure pᵢ of the startup unit 11 is directed by way of another pressure line 38 to a pressure cylinder 28 where it generates a counter pressure p_{g} which essentially equals the internal pressure pᵢ and is determined by this pressure. Embodiments of the invention wherein the startup unit 11 and the bridging clutch 10 are arranged in a common housing and exposed to the same operating fluid are also possible and can be realized in a space-saving manner. It is then particularly advantageous if the internal pressure pᵢ of the operating fluid can act directly on at least one disc of the bridging clutch for axially moving the disc without interpositions of an additional control line and a pressure cylinder.

In the second mode of operation a control line 27 by way of which the control pressure pₐₙ, generated by an additional pressure cylinder 35, can provide a force to the bridging clutch 10, is fully vented so that the clutch 10 is disengaged independent of the internal pressure pᵢ of the startup unit 11.

When operating fluid is supplied to the control valve 17 the coupling arrangement is placed into the first mode of operation, wherein the control valve 17 opens and operating fluid is admitted through the pressure line 18 to the pressure chamber 20 of the control spool valve 13. The pressure generated there acts against the force of the spring 19 and displaces the spool 13a toward the spring 19. Displacement of the spool 13a first closes the annular groove 22 when the control edge 25 of the reduced cross-section area of the spool 13a passes the annular groove 22 so that the operating pressure pₐₙ is no longer transmitted by way of the control spool valve 13 to the control line 16. Upon further movement of the spool 13a toward the spring 19, a control edge 29 of another reduced diameter section of the spool 13 reaches another annular groove 30 which provides for communication between the control line 16 and a tank 30′ thereby venting the control line 16.

With the further movement of the spool 13a toward the spring 19 a further reduced cross-section area of the control spool 13 reaches the annular groove 22 so that the operating fluid from the control pressure line 24 can flow past the control edge 21 through the gap 32 to the reduced diameter area and another annular groove 42 into the control line 27 and provide in the control line 27 a control pressure pₐₙ (FIG. 3). The control pressure pₐₙ is controlled by a release of part of the control fluid by way of restrictor 31 into a pressure chamber 43 of the control spool valve 13, in which also the spring 19 is arranged the force of which is enhanced by the pressure in the pressure chamber 43. If, with a constant pressure in the pressure chamber 20, the operating pressure pₐᵣ increases, a pressure in the pressure chamber 43, which supports the spring force will also increase, which causes movement of the spool 13a away from the spring 19 and reduces the gap 32. As a result, the controlled actuating pressure pₐₙ and, together therewith, the pressure in the pressure chamber 43 is reduced again to the pressure in the pressure chamber 20 and the value as determined by the spring 19. The controlled actuating pressure pₐₙ is derived from the operating pressure pₐᵣ by the back coupling mechanism realized in the pressure chamber 43 as described above. The control pressure pₐₙ is determined fully by the pressure as regulated by the control valve 17 and provided to the pressure chamber 20 via line 18.

At the time of venting, the pressure in the pressure chamber 26 of the control spool valve 14 drops and the spool 14a is no longer retained in position. The control spool 14a is moved to an equilibrium position which is determined by a force equilibrium between a spring 46 disposed in the pressure chamber 26 and a pressure in a pressure chamber 44 of the control spool vlave 14.

At this point, a control edge 45 narrows a gap of the control spool valve 14, so that the pressure in the pressure line 34 drops. As described above in connection with the control of the control pressure pₐₙ the internal pressure pᵢ is controlled by back-coupling of the internal pressure pᵢ by way of the pressure in the pressure chamber 44 to the constant value of 0.5 bar which is determined by the spring 45 when the lubricant pressure is higher than a threshold value of 0.5 bar.

The threshold value is determined by the spring force of the spring 46. Below the threshold value, the spring force exceeds the force generated by the pressure in the pressure space 44. The control spool 14a then abuts the stop and the flow passage between the pressurized lubricant supply line 33 and the pressure line 34 is fully open.

The lubricant pressure pₛ is derived from the operating pressure pₐₙ and is adjusted by way of a control spool valve 15 with another threshold value to a saturation value of about 5 bar. This value is, on one hand, high enough to provide for an adequate cooling in the startup unit 11 in the second mode of operation and, on the other hand, low enough to avoid material damage by high pressure loads. The value of 0.5 bar of the internal pressure pᵢ provided in the first operational mode is about 10% of the saturation value of the lubricant pressure pₛ.

The bridging clutch 10 is a multiple disc clutch and includes a first friction structure which is firmly connected to a drive shaft and a second friction structure which is axially movably supported on the drive shaft but for rotation therewith and both friction structures include friction discs.

The first pressure cylinder 28 generates a force determined by the counter pressure p_{g} and the second pressure cylinder 35 generates a force determined by the control pressure pₐₙ which opposes the force generated by the first cylinder 28, both forces being effective on the second friction structure which transfers a friction pressure force pᵣ to the first friction structure which results from the force combination of the counter pressure p_{g} and the control pressure pₐₙ. The torque transfer by the bridging clutch 10 and the slippage thereof is determined by the friction pressure pᵣ. A sensor and control arrangement which is not shown measures in the first mode of operation the difference in speed between the drive shaft and the driven shaft and supplies a current to the magnetic control value 17, which depends on that difference so that the control pressure pₐₙ and, as a result, the friction pressure p_{c} is changed by way of the pressure in the pressure chamber 20. The electronic sensor and control arrangement as a result controls the slippage at the bridging clutch 10 to a constant value in the range of 10-20 rpm. With the controlled slippage, torsion vibrations between the drive and the driven members are advantageously damped.

1. A coupling arrangement disposed between a drive shaft and a driven shaft for transferring a torque between the drive shaft and the driven shaft and comprising a startup unit (11), a control unit (12) and a bridging clutch (10) bridging the startup unit and having an engagement pressure (pᵣ) provided by a combination of a control pressure (pₐₙ) and a counter pressure (p_{g}) and a control unit (12) for controlling the counter pressure (p_{g}) in at least one state of operation of the coupling arrangement so as to permit a certain slippage of the bridging clutch (10).

2. A coupling arrangement according to claim 1, wherein the startup unit (11) comprises a hydrodynamic torque converter.

3. A coupling arrangement according to claim 1, wherein the counter pressure (p₃) is determined by an internal pressure (p_{g}) of the startup unit (11).

4. A coupling arrangement according to claim 1, wherein the control unit (12) adjusts the counter pressure (p_{g}) in at least one mode of operation to an essentially constant value.

5. A coupling arrangement according to claim 3, wherein the control unit (12) adjusts the internal pressure (pᵢ) to an essentially constant value when a fluid supply pressure is higher than a certain threshold value.

6. A coupling arrangement according to claim 5, wherein the threshold value is less than 20% of a saturation value.

7. A coupling arrangement according to claim 5, wherein the threshold value is in the range of 03 to 1 bar.

8. A coupling arrangement according to claim 3, wherein the control unit (12) includes at least one control spool valve (13, 14, 15).

9. A coupling arrangement according to claim 8, wherein the internal pressure (pᵢ) is derived from lubricant pressure (pₛ) by way of the control spool valve (14).

10. A coupling arrangement according to claim 5, wherein the bridging clutch (10) can be engaged by the control unit (12) only when the internal pressure (pᵢ) is adjusted to the constant value.

11. A coupling arrangement according to claim 8, wherein the control unit (12) retains the control spool valve (14) in at least one mode of operation in an open position.

12. A coupling arrangement according to claim 11, wherein the spool (14a) of the control spool valve (14) is retained in position by an operating pressure (pₐᵣ) in at least one operating state.

13. A coupling arrangement according to claim 8, wherein a first control spool valve (14) is provided for providing the internal pressure (pᵢ) and a second control spool valve (13) is present for providing the control pressure (pₐₙ).

14. A coupling arrangement according to claim 13, wherein the control spool valve (14) for the internal pressure (pᵢ) can be retained in a position by means of the second control spool valve (13) for the control pressure (pₐₙ) by way of at least one control line (16).

15. A method of coupling a drive shaft and a driven shaft joined by way of a coupling arrangement compromising a startup unit (11) arranged between the drive shaft and the driven shaft, a control unit (12) and a bridging clutch (10) bridging the startup unit (11) and having an engagement pressure (pᵣ) provided by a combination of a control pressure (pₐₙ) and a counter pressure (pₛ), wherein the control unit (12) controls the counter pressure (p_{g}) in at least one operating state to a value so as to permit a certain slippage of the bridging clutch (10).
